(19) United States
(12) Patent Application Publication
(10) Pub. No.: US 2021/0079320 A1
(43) Pub. Date: Mar. 18, 2021

(54) LIQUID CONSUMER PRODUCT COMPOSITIONS COMPRISING PARTICLES

(71) Applicant: The Procter & Gamble Company, Cincinnati, OH (US)

(72) Inventors: Johan SMETS, Lubbeek (BE); Paolo TEMPESTI, Impruneta (FI) (IT); Hugo Robert Germain DENUTTE, Hofstade (Aalst) (BE); Arianna BARTOLINI, Florence (IT); Piero BAGLIONI, Fiesole Firenza (IT)

(21) Appl. No.: 17/016,418

(22) Filed: Sep. 10, 2020

(30) Foreign Application Priority Data
Sep. 17, 2019 (EP) 19197694.3

(51) Int. Cl. C11D 3/50; C11D 17/04; C11D 3/37; C11D 3/12

(52) U.S. Cl. CPC C11D 3/505; C11D 3/122; C11D 3/3707; C11D 17/043

(57) ABSTRACT

Liquid consumer product compositions that include fragrance-delivery particles, where the particles include a graft copolymer, the graft polymer including a polyalkylene glycol as a graft base and one or more side chains that include vinyl acetate moieties. Related processes of making and using such compositions.

### FIELD OF THE INVENTION

The present disclosure relates to liquid consumer product compositions that include fragrance-delivery particles. The particles include a graft copolymer, which includes a polyalkylene glycol as a graft base and one or more side chains that include vinyl acetate moieties. The present disclosure also relates to related processes.

### BACKGROUND OF THE INVENTION

Liquid detergent compositions remain very popular, but many formulations tend to be relatively dilute. However, manufacturers, vendors, and/or consumers may prefer more compact formulations, or even water-soluble unit dose article, that have relatively less water. For example, compact liquid detergents may provide various environmental benefits, as formulations with less water require less packaging and/or lower transportation costs per dose.

That being said, compact liquid detergents can present formulation and/or stability challenges to the manufacturer. For example, many perfume ingredients, such as aldehydes and ketones, may contribute to color changes of the liquid product upon storage. These color changes may be particularly pronounced in compact detergents that contain relatively low amounts of water; formulations that are more dilute may not experience changes to the same degree, thereby having more formulation flexibility. This may cause the manufacturer to undergo the arduous task of developing and testing new perfumes that are resistant to color changes in compact formulations, avoid certain perfume raw materials and/or adjuncts, and/or maintain a wide variety of perfumes, each of which are compatible with certain products but not others.

To shield perfume raw materials from other adjuncts in a formulation, perfumes may be encapsulated in core-in-shell capsules. However, the encapsulation process, typically involving interfacial polymerization reactions, can be resource- and time-intensive.

There is a need to improve the color-stability of certain compact liquid detergent compositions that include perfume.

### SUMMARY OF THE INVENTION

The present disclosure relates to liquid consumer product compositions that include fragrance-delivery particles.

For example, the present disclosure relates to liquid consumer product compositions that include fragrance-delivery particles and a consumer product adjunct, the fragrance-delivery particles including a graft copolymer and a fragrance material, the graft copolymer including a polyalkylene glycol as a graft base and one or more side chains that include vinyl acetate moieties; the fragrance material including perfume raw materials that include an aldehyde moiety, perfume raw materials that include a ketone moiety, perfume raw materials that include a phenol moiety, or a mixture thereof.

The present disclosure also relates to liquid consumer product compositions that include fragrance-delivery particles and a consumer product adjunct, the fragrance-delivery particles including a graft copolymer and a fragrance material, the graft copolymer including a polyalkylene glycol as a graft base and one or more side chains that include vinyl acetate moieties; the fragrance material including a perfume raw material selected from: 2,6,10-trimethyl-9-undecenal; amyl cinnamic aldehyde; anisaldehyde; citral; citronellal; cyclal c; cyclamen aldehyde; ethyl vanillin; floralozone; helional; heliotropin; hexyl cinnamic aldehyde; lilial; myrac aldehyde; phenyl acetaldehyde; triplal; undecylenic aldehyde; vanillin; alpha-ionone; beta-ionone; laevo carvone; alpha damascone; delta damascone; iso e super; methyl ionone; eugenol; or mixtures thereof.

The present disclosure also relates to processes for making a liquid consumer product composition, the process including the steps of: providing a fragrance material, the fragrance material including perfume raw materials that comprise an aldehyde moiety, perfume raw materials that comprise a ketone moiety, perfume raw materials that comprise a phenol moiety, or a mixture thereof; combining the fragrance material with a graft copolymer to form a feedstock composition, the graft copolymer including a polyalkylene glycol as a graft base and one or more side chains that include vinyl acetate moieties; combining the feedstock composition with a consumer product adjunct to form a liquid consumer product composition, where the consumer product composition includes perfume-delivery particles formed from the fragrance material and the graft copolymer of the feedstock composition.

The present disclosure also relates to liquid consumer product compositions formed by such processes.

The present disclosure also relates to processes of treating a surface, where the processes including the step of contacting the surface with the consumer product composition according to those described in the present disclosure.

### DETAILED DESCRIPTION OF THE INVENTION

The present disclosure relates to compact liquid detergents that include particles. The particles comprise a graft copolymer and perfume raw materials. The perfume raw materials include one or more compounds that tend to lead to discoloration in compact liquid detergent products when neat. Problematically, some of these discoloring perfume raw materials, such as vanillin and/or ethyl vanillin, have characters that are well-liked by consumers, and are thus desirable to detergent manufacturers so that the product will have and provide a pleasant scent.

It has been surprisingly been found that providing particles according to the present disclosure, including the graft copolymer and the particular perfume raw materials according to the present disclosure, helps to mitigate the discoloration problem in compact liquid detergent compositions. In addition to reducing the color change associated with any particular perfume material, this approach offers flexibility to the detergent manufacturer, who may choose to use a given perfume material in a wider variety of products, such as compact and dilute liquid detergents.

Without wishing to be bound by theory, it is believed that the particles are formed by the graft copolymer self-assembling into particle form, with the perfume raw materials encapsulated and/or embedded in the three-dimensional structure formed by graft copolymer. It is believed that the copolymer isolates and/or shields the perfume raw materials from other ingredients in the detergent matrix that might otherwise interact with the perfume raw materials and cause discoloration.

These particles remain present in the environment of the compact liquid detergent composition, where there are relatively low levels of free water. However, when the composition is diluted by water during intended use to make a wash liquor, for example in an automatic washing machine, the particles dissemble, with the graft copolymers “opening up” and the perfume materials being released.

The particles, compositions, and related processes are discussed in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, “liquid” includes free-flowing liquids, as well as pastes, gels, foams and mousses. Non-limiting examples of liquids include light duty and heavy duty liquid detergent compositions, fabric enhancers, detergent gels commonly used for laundry, bleach and laundry additives. Other non-limiting examples of liquids according to the present disclosure include shampoos, hair conditioners, body cleansing compositions, and the like. Gases, e.g., suspended bubbles, or solids, e.g. particles, may be included within the liquids. A “solid” as used herein includes, but is not limited to, powders, agglomerates, and mixtures thereof. Non-limiting examples of solids include: granules, micro-capsules, beads, noodles, and pearlised balls.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Liquid Consumer Product Composition

The present disclosure relates to liquid consumer product composition. The compositions may be liquid detergent compositions, for example compact liquid detergent compositions. The compositions may be fabric care compositions, hard surface cleaner compositions, dish care compositions, hair care compositions, body cleansing compositions, or mixtures thereof.

The compositions of the present disclosure may be fabric care compositions. Such compositions may be used as a pre-laundering treatment, a post-laundering treatment, or may be added during the rinse or wash cycle of the laundering operation.

The composition may be selected from the group of heavy duty liquid detergent compositions, light duty liquid detergents compositions, detergent gels commonly used for laundry, bleaching compositions, laundry additives, fabric enhancer compositions, and mixtures thereof. The composition may be a compact heavy duty liquid detergent composition. Other non-limiting examples of liquid compositions according to the present disclosure include shampoos, body cleansing compositions, and the like.

The composition may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof; at least one encapsulated composition is a liquid composition. Unit dose articles such as pouches and water-soluble films are described in more detail below.

The composition may be characterized by a viscosity. The composition may have a viscosity of from about 1 to about 1500 centipoises (about 1-1500 mPa*s), from about 100 to 1000 centipoises (about 100-1000 mPa*s), or from about 200 to 500 centipoises (about 200-500 mPa*s) at 20 s⁻¹ and 21° C., is disclosed. Viscosity is determined according to the method provided in the Test Methods section below.

### Particles

The present disclosure relates to particles. The particles comprise a graft copolymer and certain perfume raw material(s). The perfume raw materials may be encapsulated in at least one graft copolymer, and/or embedded in at least one graft copolymer. Compositions of the present disclosure may comprise the presently described particles.

The particles of the present disclosure may be present in a population, which may have a number-weighted average diameter (or “diameter” as used herein). Number-weighted average diameter is determined according to the method provided in the test method section below. The particles may have a number-weighted average diameter of (a) from about 0.5 microns to about 5000 microns, preferably from about 0.5 microns to about 1000 microns, more preferably from about 0.5 microns to about 250 microns, most preferably from about 1 microns to about 60 microns, and/or (b) from about 0.01 microns to about 0.5 microns, preferably from about 0.02 microns to about 0.5 microns, more preferably from about 0.04 microns to about 0.5 microns, and/or (c) from about 250 microns to about 10,000 microns, preferably from about 250 microns to about 7500 microns, more preferably from about 500 microns to about 5000 microns, most preferably from about 750 microns to about 2500 microns. The compositions of the present disclosure may have mixtures of particles having number-weighted average diameters according to (a), (b), and/or (c).

The particles of the present disclosure may be characterized by a self-assembly index of from about 1 to about 100. The particles of the present disclosure may be characterized by a SAXS index of from about 1 to about 100. The particles of the present disclosure may be characterized by a Dissolution Index, for example a Dissolution Index of 1. Test methods to determine the self-assembly index, the SAXS index, and/or the Dissolution Index may be found in US2018/0071201 to The Procter & Gamble Company, paragraphs [0177]-[0274], incorporated herein by reference.

One or more particles of the present disclosure may comprise at least one region comprising a perfume raw material. The region may comprise a perfume raw material being encompassed or encapsulated within the graft copolymer. The region may comprise a perfume raw material being embedded, for example partially embedded, within the graft copolymer.

One or more particles of the present disclosure may have a structure selected from the group consisting of: (a) a particle comprising a single region having perfume raw material that is embedded in said at least one graft copolymer; (b) a particle comprising at least two regions having perfume raw materials that are embedded in said at least one graft copolymer; a particle comprising at least one region having perfume raw material that is at least partially embedded on the surface of at least one graft copolymer; (d) a particle comprising a single region having perfume raw material that is embedded in the graft copolymer and at least one region having perfume raw material that is at least partially embedded on the surface of the at least one graft copolymer; and (e) a particle comprising at least two regions having perfume raw materials that are embedded in the at least one graft copolymer and at least one region having perfume raw material that is at least partially embedded on the surface of the at least one polymer. Compositions of the present disclosure may include one or more particles having a structure according to (a)-(e), or mixtures thereof.

The particles may be characterized by a weight ratio of the perfume raw material to the graft copolymer. The weight ratio of the perfume raw material to the graft copolymer may be from about 1:20 to about 20:1, preferably from about 4:1 to 20:1 are disclosed. The weight ratio is the ratio between the total weight of the perfume raw materials and the total weight of the graft copolymers in the population of particles. For the purposes of this ratio, the total weight of the perfume raw materials and/or the graft copolymers does not include free perfume raw materials and/or free graft copolymers in the composition that are not part of a particle.

The graft copolymers and the perfume raw materials of the particles are described in more detail below.

a. Graft Copolymer

The particles of the present disclosure comprise a graft copolymer. A graft copolymer molecule includes of a polymeric main chain, constituted of a long sequence of one monomer (the backbone), on which one or more polymeric side chains, constituted of monomers of a different chemical nature than the backbone, are attached. In graft copolymers a large number of parameters can be varied: the chemical nature, the molecular weight and the molecular weight distribution (MWD) of both the backbone and of the grafts, and the graft density along the backbone. Therefore, graft copolymers represent materials combining the properties of two or more polymers in one entity. Provided appropriate polymerization methods are used, tailor-made graft copolymers can be obtained. In common graft copolymers, the branches are randomly distributed along the backbone. The backbone and the branches may be homo- or copolymers but they differ in chemical nature or composition. Under the synthetic conditions used herein, the graft copolymer will also contain low levels of backbone homopolymer and side-chain graft homopolymer in addition to the graft copolymer itself.

By varying the nature and ratios of the polymers used in the backbone and in the graft, it is possible to obtain graft co-polymers of different amphiphilicity. Suitable graft copolymers according to the present disclosure may include graft copolymers comprising a few long Poly Vinyl Acetate (PVAc) chains hanging off a Polyethylene (PEG) backbone. The graft co-polymer normally has only few graft points (e.g., only 1-3 PVAc grafts per the whole PEG chain, where the PEG chain is about 140 units long) with long PVAc chains.

The graft copolymer of the present disclosure may include a polyalkylene backbone, preferably a polyalkylene glycol backbone. Preferably, the polyalkylene glycol comprises a material selected from the group consisting of polyethylene glycol, polypropylene glycol, polybutylene glycol and mixtures thereof, more preferably said polyalkylene glycol comprises polyethylene glycol, are disclosed. Most preferably, the graft copolymer comprises a polyethylene glycol (“PEG”) backbone. The PEG backbone may have, prior to grafting, a weight average molecular weight from about 2000 to about 15,000 Daltons, or from about 4000 to about 12,000 Daltons, or from about 6000 to about 12,000 Daltons.

The graft copolymer may comprise polyalkylene glycol and at least one monomer selected from the group consisting of vinyl esters, alkyl acrylates, alkyl methacrylates, alkyl acrylamides, alkyl methacrylamides, styrenes, halogenated olefins, and mixtures thereof, preferably said copolymer of polyalkylene glycol comprises polyethylene glycol.

The graft copolymer may comprise polyalkylene glycol and vinyl acetate. The graft copolymer may comprise a polyalkylene glycol backbone comprising vinyl acetate moieties that are covalently attached to said polyalkylene glycol backbone, preferably said co-polymer of polyalkylene glycol comprises polyethylene glycol.

The graft copolymer may comprise at least one copolymer of polyalkylene glycol and vinyl acetate that has from 1 to about 10 vinyl acetate grafts per polyalkylene glycol backbone, preferably said copolymer of polyalkylene glycol and vinyl acetate has from 1 to about 5 vinyl acetate grafts per polyalkylene glycol backbone, more preferably from about 1 to about 3 vinyl acetate grafts per polyalkylene glycol backbone, most preferably about 1 vinyl acetate graft per polyalkylene glycol backbone, where preferably the copolymer of polyalkylene glycol comprises polyethylene glycol.

The copolymer may have, on average, based on the reaction mixture obtained, not more than 1 graft site, preferably not more than 0.6 graft site, more preferably not more than 0.5 graft site and most preferably not more than 0.4 graft site per 50 alkylene oxide units. They may comprise, on average, based on the reaction mixture obtained, preferably at least 0.05, in particular at least 0.1 graft site per 50 alkylene oxide units. The degree of branching can be determined, for example, by means of ¹³C NMR spectroscopy from the integrals of the signals of the graft sites and the —CH2-groups of the polyalkylene oxide.

The graft copolymer may include vinyl acetate monomers that have hydrolyzed, effectively resulting in hydroxyl-containing polyvinyl alcohol monomers in the graft copolymer. Thus, the graft copolymer may be characterized by a degree of hydrolysis. Typically, the degree of hydrolysis is relatively low, such as less than 30 mol %, or less than 20 mol %, or less than 10 mol %, or less than 5 mol %, or less than 3 mol %, or from about 0.1 mol % to about 3 mol %. The degree of hydrolysis, as mol %, is based on the total moles of polyvinyl acetate originally present in the graft copolymer, or, after hydrolysis has occurred, the combined moles of polyvinyl alcohol monomers and polyvinyl acetate monomers in the graft copolymer. A relatively low degree of hydrolysis may be preferred so that the copolymer maintains sufficient amphiphilic character; it is believed that as more polyvinyl acetate moieties are hydrolyzed, relatively hydrophobic character is lost, and particles are formed less effectively, particularly in aqueous environments. The degree of hydrolysis may be determined by measuring the amount of free acetic acid via a pH titration according to methods known in the literature.

The graft copolymer may be characterized by (a) a weight-average molecular weight of from about 2000 Daltons to about 250,000 Daltons, preferably from about 3000 Daltons to about 100,000 Daltons, more preferably 4,000 Daltons to about 50,000 Daltons, most preferably from about 5,000 to about 20,000 Daltons; (b) a weight ratio of polyalkylene glycol (preferably polyethylene glycol) to vinyl acetate moieties of about 5:1 to about 1:10 preferably from about 3:1 to about 1:8, more preferably from about 2:1 to about 1:6; or both. Preferably, the polyalkylene glycol comprises a material selected from the group consisting of polyethylene glycol, polypropylene glycol, polybutylene glycol and mixtures thereof, more preferably said polyalkylene glycol comprises, or even is, polyethylene glycol.

The graft copolymer may comprise (A) from 20 to 70% by weight of a water-soluble polyalkylene oxide as a graft base and (B) side chains formed by free-radical polymerization of from 30 to 80% by weight of a vinyl ester component composed of (B1) from 70 to 100% by weight of vinyl acetate and/or vinyl propionate and (B2) from 0 to 30% by weight of a further ethylenically unsaturated monomer in the presence of (A). The graft copolymers may comprise from 25 to 60% by weight of the graft base (A) and from 40 to 75% by weight of the polyvinyl ester component (B), preferably wherein the relative weight % of (A) and (B) add up to 100% by weight of the copolymer.

The graft copolymer may be characterized by a hydrodynamic diameter of from about 10 nanometers to about 100 nanometers, more preferably from about 15 nanometers to about 80 nanometers, most preferably from about 20 nanometers to about 60 nanometers.

The graft copolymer may be characterized by a surface energy of from about 20 to about 90 mJ/m², preferably from about 20 to about 75 mJ/m², more preferably from about 20 to about 50 mJ/m². The test method to determine surface energy may be found in US2018/0071201 to The Procter & Gamble Company, paragraphs [0174]-[0176], incorporated herein by reference.

The graft copolymer may be considered a self-assembling graft copolymer. In the present disclosure, by “self-assembling,” it is meant more than one polymer come together to make a particle through dispersion forces in a particular matrix, such as a detergent matrix, without requiring cross-linking or other reactions or additives.

b. Perfume Raw Materials

The particles of the present disclosure comprise one or more perfume raw materials. The term “perfume raw material” (or “PRM”) as used herein refers to compounds having a molecular weight of at least about 100 g/mol and which are useful in imparting an odor, fragrance, essence, or scent, either alone or with other perfume raw materials. Typical PRMs comprise inter alia alcohols, ketones, aldehydes, esters, ethers, nitrites, and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs may be characterized by their boiling points (B.P.) measured at the normal pressure (760 mm Hg), and their octanol/water partitioning coefficient (P), which may be described in terms of log P, determined according to the test method below. Based on these characteristics, the PRMs may be categorized as Quadrant I, Quadrant II, Quadrant III, or Quadrant IV perfumes, as described in more detail below. A perfume having a variety of PRMs from different quadrants may be desirable, for example, to provide fragrance benefits at different touchpoints during normal usage.

The perfume raw materials may comprise a perfume raw material selected from the group consisting of perfume raw materials having a boiling point (B.P.) lower than about 250° C. and a C log P lower than about 3, perfume raw materials having a B.P. of greater than about 250° C. and a C log P of greater than about 3, perfume raw materials having a B.P. of greater than about 250° C. and a C log P lower than about 3, perfume raw materials having a B.P. lower than about 250° C. and a C log P greater than about 3 and mixtures thereof. Perfume raw materials having a boiling point B.P. lower than about 250° C. and a C log P lower than about 3 are known as Quadrant I perfume raw materials. Quadrant 1 perfume raw materials are preferably limited to less than 30% of the perfume composition. Perfume raw materials having a B.P. of greater than about 250° C. and a C log P of greater than about 3 are known as Quadrant IV perfume raw materials, perfume raw materials having a B.P. of greater than about 250° C. and a C log P lower than about 3 are known as Quadrant II perfume raw materials, perfume raw materials having a B.P. lower than about 250° C. and a C log P greater than about 3 are known as a Quadrant III perfume raw materials. Suitable Quadrant I, II, III and IV perfume raw materials are disclosed in U.S. Pat. No. 6,869,923 B1.

The compositions of the present disclosure may comprise PRMs that include aldehyde moieties, PRMs that include ketone moieties, and/or PRMs that include phenol moieties, as such PRMs may result in discoloration when otherwise present in a composition. Without wishing to be bound by theory, it is believed that when present in neat form, PRMs that contain aldehyde, ketone, and/or phenol moieties can oxidize and result in discoloration; the oxidation can result from reactions with other ingredients in a composition, or even with atmospheric oxygen. Furthermore, it is believed that when present in neat form, PRMs that contain aldehyde and/or ketone moieties may react with amines, resulting, for example, in Schiff base reactions that can lead to discoloration.

Furthermore, the perfume raw materials that comprise an aldehyde, ketone, and/or phenol moiety according to the present disclosure may further comprise one or more carbon double bonds (C═C) and/or an aromatic ring structure. Without wishing to be bound by theory, it is believed that such structures in perfume raw materials can act as strong chromophores, thereby resulting in discoloration of compositions that comprise such PRMs.

Table A below provides PRMs that include aldehyde, ketone, and/or phenol moieties. Further, it is believed that the PRMs listed in Table A are prone to reactions that can cause discoloration, and are therefore particularly suitable to be combined in a particle with the polymers of the present disclosure. The compositions of the present disclosure may comprise any of the PRMs provided in Table A, or mixtures thereof.

TABLE A

| Category | PRM name | CAS # |
|---|---|---|
| Aldehyde | 2,6,10-Trimethyl-9-undecenal | 141-13-9 |
| Aldehyde | amyl cinnamic aldehyde | 122-40-7 |
| Aldehyde | anisaldehyde | 123-11-5 |
| Aldehyde | citral | 5392-40-5 |
| Aldehyde | citronellal | 106-23-0 |
| Aldehyde | cyclal c | 68039-49-6 |
| Aldehyde | cyclamen aldehyde | 103-95-7 |
| Aldehyde | ethyl vanillin | 121-32-4 |
| Aldehyde | floralozone | 67634-15-5 |
| Aldehyde | helional | 1205-17-0 |
| Aldehyde | heliotropin | 120-57-0 |
| Aldehyde | hexyl cinnamic aldehyde | 101-86-0 |
| Aldehyde | lilial | 80-54-6 |
| Aldehyde | myrac aldehyde | 37677-14-8 |
| Aldehyde | phenyl acetaldehyde | 122-78-1 |
| Aldehyde | triplal | 68039-49-6 |
| Aldehyde | undecylenic aldehyde | 112-45-8 |
| Aldehyde | vanillin | 121-33-5 |
| Ketone | alpha-ionone | 127-41-3 |
| Ketone | beta-ionone | 79-77-6 |
| Ketone | laevo carvone | 6485-40-1 |
| Ketone | alpha damascone | 24720-09-0 |
| Ketone | delta damascone | 57378-68-4 |
| Ketone | iso e super | 54464-57-2 |
| Ketone | methyl ionone | 1335-46-2 |
| Phenol | eugenol | 97-53-0 |

It is believed that when such PRMs are free in a composition, relatively greater levels of such PRMs can result in relatively greater degrees of discoloration. Therefore, particles according to the present disclosure may be useful for delivering relatively greater levels of such PRMs, and such levels may be preferred. The compositions of the present disclosure may comprise from about 0.05% to about 10%, or from about 0.05% to about 5%, or from about 0.1% to about 4%, by weight of the composition, of perfume raw materials. The compositions of the present disclosure may comprise from about 0.01% to about 5%, or from about 0.02% to about 5%, or from about 0.05% to about 4%, by weight of the composition, of PRMs that comprise an aldehyde moiety, PRMs that comprise a ketone moiety, PRMs that comprise a phenol moiety, or a mixture thereof, preferably one or more PRMs provided in Table A or a mixture thereof. The compositions of the present disclosure may comprise from about 1% to about 75%, or from about 2% to about 70%, or from about 3% to about 65%, or from about 4% to about 60%, or from about 10% to about 60%, or from about 20% to about 50%, by weight of the total amount of PRMs, of PRMs that comprise an aldehyde moiety, PRMs that comprise a ketone moiety, PRMs that comprise a phenol moiety, or a mixture thereof, preferably one or more PRMs provided in Table A or a mixture thereof. If a particular PRM comprises at least two of aldehyde, ketone, and/or phenol moieties, the PRM is to be counted only once for such % determinations.

### Water

The liquid compositions of the present disclosure may comprise limited amounts of free water, if any. The amount of free water is determined according to the test method section below. Without wishing to be bound by theory, it is believed that the reactions leading to discoloration are more pronounced in more concentrated formulations or formulations that contain relatively low amounts of water.

The compositions of the present disclosure may comprise less than 50 wt %, or less than 40 wt %, or less than 30 wt %, or less than 20 wt %, or less than 15 wt %, or less than 12 wt %, or less than 10 wt %, by weight of the composition, of free water.

The liquid compositions of the present disclosure may be substantially non-aqueous, and may comprise less than 10 wt %, or less than 5 wt %, or less than 3 wt %, or less than 1 wt %, or less than 0.1 wt %, or even 0 wt %, by weight of the composition, of free water.

The free water level may depend on the form and/or intended use of the composition. For example, when the composition is in the form of a unit dose composition (for example, a liquid composition encapsulated by a water-soluble film), the free water may be from about 1% to about 20%, or from about 5% to about 15%; when the composition is in the form of a compact liquid laundry detergent, the free water may be from about 10% to about 50%, or from about 20% to about 40%.

### Adjunct Ingredients

The compositions of the present disclosure may include other adjunct ingredients. The adjuncts may be suitable for delivering a treatment benefit to a target surface, such as a fabric or other textile. Adjuncts ingredients, as used herein, may also include agents that facilitate chemical or physical stability in the treatment compositions, such as buffers, structurants/thickeners, and/or carriers.

The adjunct ingredient(s) may be present in the composition at levels suitable for the intended use of the composition. Typical usage levels range from as low as 0.001% by weight of composition for adjuncts such as optical brighteners to 50% by weight of composition for builders.

The adjunct may include an amine, a surfactant system, a water-binding agent, a sulfite, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, free perfume, structure elasticizing agents, fabric softeners, carriers, fillers, hydrotropes, organic solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

The compositions of the present disclosure may include, among other things, an amine, a surfactant system, a water-binding agent, a sulfite, a structurant, organic solvent, free perfume, or mixtures thereof. Several of these adjuncts are described in more detail below.

Amine

The compact liquid detergent compositions of the present disclosure may comprise an amine. The amine may be present in order to provide a processing, stability, or performance benefit to the composition.

While the presence of amines may be generally advantageous for any of the reasons provided above, amine compounds may interact with certain perfume raw materials, leading to undesirable discoloration. For example, perfume raw materials that include ketone and/or aldehyde moieties may react with amines to form Schiff bases.

The amine may be selected from an alkanolamine, an amine-containing polymer, an oligoamine, or mixtures thereof.

Alkanolamines may be useful as a neutralizer, pH buffer, and/or a solvent. The alkanolamines may be selected from monoalkanolamine, dialkanolamine, trialkanolamine, or mixtures thereof, preferably monoethanolamine, diethanolamine, triethanolamine, or mixtures thereof. The alkanolamine may be present at a level of from about 1% to about 20%, or from about 2% to about 10%, by weight of the liquid detergent composition.

Amine-containing polymers may be useful for providing cleaning or viscosity-modification benefits. Amine-containing polymers according to the present disclosure may include alkyleneimine polymers. Such polymers may be linear, branched, or a mixture thereof. Such polymers may be alkoxylated, non-alkoxylated, or a mixture thereof. The amine-containing polymers may be an alkoxylated polyethyleneimine (PEI) polymer. Such PEI polymers may facilitate viscosity modification of the compositions. The alkoxylated polyalkylenimine may be present in the composition at a level of from about 0.1% to about 5%, or from about 0.5% to about 4.5%, preferably from about 0.75% to about 1.5%, by weight of the composition. The alkoxylated polyalkyleneimine polymer, preferably alkoxylated PEI, may comprise ethoxylate (EO) groups, propoxylate (PO) groups, or combinations thereof. The alkoxylated polyalkyleneimine polymer, preferably alkoxylated PEI, may comprise ethoxylate (EO) groups. The alkoxylated polyalkyleneimine polymer, preferably alkoxylated PEI, may be free of propoxylate (PO) groups. The alkoxylated polyalkyleneimine polymer, preferably alkoxylated PEI, may comprise on average per alkoxylated nitrogen, about 1-50 ethoxylate (EO) groups and about 0-30 propoxylate (PO) groups. The alkoxylated polyalkylenimine may be linear, branched, or combinations thereof, preferably branched. Suitable alkoxylated polyalkyleneimines, such as PEI600 EO20 and/or PEI600 EO24 P016, are available from BASF (Ludwigshafen, Germany).

The amine may be an oligoamine. The oligoamines of the present disclosure may have a molecular weight of between about 100 to about 1200 Da, or from about 100 to about 900 Da, or from about 100 to about 600 Da, or from about 100 to about 400 Da, preferably between about 100 Da and about 250 Da, most preferably between about 100 Da and about 175 Da, or even between about 100 Da and about 150 Da. For purposes of the present disclosure, the molecular weight is determined using the free base form of the oligoamine.

Suitable oligoamines according to the present disclosure may include diethylenetriamine (DETA), 4-methyl diethylenetriamine (4-MeDETA), dipropylenetriamine (DPTA), 5-methyl dipropylenetriamine (5-MeDPTA), triethylenetetraamine (TETA), 4-methyl triethylenetetraamine (4-MeTETA), 4,7-dimethyl triethylenetetraamine (4,7-Me2TETA), 1,1,4,7,7-pentamethyl diethylenetriamine (M5-DETA), tripropylenetetraamine (TPTA), tetraethylenepentaamine (TEPA), tetrapropylenepentaamine (TPPA), pentaethylenehexaamine (PEHA), pentapropylenehexaamine (PPHA), hexaethyleneheptaamine (HEHA), hexapropyleneheptaamine (HPHA), N,N′-Bis(3-aminopropyl)ethylenediamine, or mixtures thereof. The oligoamine may be selected from: DETA; 4-methyl DETA; and mixtures thereof; preferably DETA (unalkylated diethylenetriamine).

Surfactant System

Compact liquid detergent compositions according to the present disclosure may include a surfactant system. The surfactant system may consist of one type of surfactant. The surfactant system may include more than one surfactant.

The compositions of the present disclosure may include from about 20% to about 75%, or from about 25% to about 70%, or from about 30% to about 50%, by weight of the composition, of a surfactant system.

The surfactant system may include anionic surfactant, nonionic surfactant, zwitterionic surfactant, cationic surfactant, amphoteric surfactant, or combinations thereof. The surfactant system may include linear alkyl benzene sulfonate, alkyl ethoxylated sulfate, alkyl sulfate, nonionic surfactant such as ethoxylated alcohol, amine oxide, or mixtures thereof. The surfactants may be, at least in part, derived from natural sources, such as natural feedstock alcohols.

Suitable anionic surfactants may include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. The anionic surfactants may be linear, branched, or combinations thereof. Preferred surfactants include linear alkyl benzene sulfonate (LAS), alkyl ethoxylated sulfate (AES) including sodium laureth sulfate (SLES), alkyl sulfates (AS) including sodium lauryl sulfate (SLS), or mixtures thereof. Other suitable anionic surfactants include branched modified alkyl benzene sulfonates (MLAS), methyl ester sulfonates (MES), and/or alkyl ethoxylated carboxylates (AEC). The anionic surfactants may be present in acid form, salt form, or mixtures thereof. The anionic surfactants may be neutralized, in part or in whole, for example, by an alkali metal (e.g., sodium) or an amine (e.g., monoethanolamine).

The surfactant system may include nonionic surfactant. Suitable nonionic surfactants include alkoxylated fatty alcohols, such as ethoxylated fatty alcohols. Other suitable nonionic surfactants include alkoxylated alkyl phenols, alkyl phenol condensates, mid-chain branched alcohols, mid-chain branhed alkyl alkoxylates, alkylpolysaccharides (e.g., alkylpolyglycosides), polyhydroxy fatty acid amides, ether capped poly(oxyalkylated) alcohol surfactants, and mixtures thereof. The alkoxylate units may be ethyleneoxy units, propyleneoxy units, or mixtures thereof. The nonionic surfactants may be linear, branched (e.g., mid-chain branched), or a combination thereof. Specific nonionic surfactants may include alcohols having an average of from about 12 to about 16 carbons, and an average of from about 3 to about 9 ethoxy groups, such as C12-C14 EO7 nonionic surfactant.

Suitable zwitterionic surfactants may include any conventional zwitterionic surfactant, such as betaines, including alkyl dimethyl betaine and cocodimethyl amidopropyl betaine, C₈ to C₁₈ (for example from C₁₂ to C₁₈) amine oxides (e.g., C₁₂₋₁₄ dimethyl amine oxide), and/or sulfo and hydroxy betaines, such as N-alkyl-N,N-dimethylamino-1-propane sulfonate where the alkyl group can be C₈ to C₁₈, or from C₁₀ to C₁₄. The zwitterionic surfactant may include amine oxide.

It is believed that compositions having certain surfactant types at certain levels, for example nonionic surfactant such as ethoxylated alcohol, and/or anionic surfactant such as linear alkyl benzene sulphonate (LAS), are particularly likely to facilitate the self-assembly of particles. For example, the compositions of the present disclosure may include, by weight of the composition: from about 2%, to about 15%, or from about 4% to about 12%, of nonionic surfactant, such as an ethoxylated alcohol; and/or from about 0% (including none) to about 8%, or from about 1% to about 6%, of LAS. The total amount of nonionic surfactant (e.g., ethoxylated alcohol) and LAS may be from about 4% to about 15%, or from about 6% to about 12%, by weight of the composition. The weight ratio of nonionic surfactant (e.g., ethoxylated alcohol) to LAS may be from about 1:3 to about 1:0, or from about 1:1 to about 15:1.

Conditioning Active

The compositions of the present disclosure may include a conditioning active. Compositions that contain conditioning actives may provide softness, anti-wrinkle, anti-static, conditioning, anti-stretch, color, and/or appearance benefits. Conditioning actives suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof.

Conditioning actives may be present at a level of from about 1% to about 99%, by weight of the composition. The composition may include from about 1%, or from about 2%, or from about 3%, to about 99%, or to about 75%, or to about 50%, or to about 40%, or to about 35%, or to about 30%, or to about 25%, or to about 20%, or to about 15%, or to about 10%, by weight of the composition, of conditioning active. The composition may include from about 5% to about 30%, by weight of the composition, of conditioning active.

Water-Binding Agents

A water-binding agent can be added to a liquid composition to lower its free water content. The water-binding agents may comprise organic acids, salts of organic acids, humectants, desiccants, natural sugar substitutes, artificial sugar substitutes, hydrogels, or mixtures thereof.

Organic acids and salts thereof can be selected but not limited from the group consisting of citric acid, maleic acid, fumaric acid, salts thereof or mixtures thereof, preferably citric acid or salts thereof.

Humectants can be selected but not limited from the group consisting of 1,2,6-hexanetriol, butylene glycol, dipropylene glycol, glycerin, hexylene, glycol, panthenol, phytantriol, propylene glycol, sorbitol, triethylene glycol, polyglyceryl sorbitol, glucose, fructose, polydextrose, urea, hyaluronic acid, inositol, hexanediol beeswax, hexanetriol beeswax, hydrolyzed elastin, hydrolyzed collagen, hydrolyzed silk, hydrolyzed keratin, erythritol, capryl glycol, isoceteth-(3-10, 20, 30), isolaureth-(3-10, 20, 30), laneth-(5-50), laureth-(1-30), steareth-(4-20), trideceth-(5-50).

Desiccants can be selected but not limited from the group consisting of activated alumina, aerogel, benzophenone, bentonite clay, calcium chloride, calcium sulfate, cobalt(ii) chloride, copper(ii) sulfate, lithium chloride, lithium bromide, magnesium sulfate, magnesium perchlorate, molecular sieve, potassium carbonate, silica gel, sodium chlorate, sodium chloride, sodium hydroxide, sodium sulfate, sucrose.

Natural sugar substitutes can be selected but not limited from the group consisting of brazzein, curculin, erythritol, glycyrrhizin, glycerol, hydrogenated starch hydrolysates, inulin, isomalt, lactitol, luo han guo, mabinlin, maltitol, mannitol, miraculin, monatin, sclerochiton ilicifolius, monellin berries, osladin, pentadin, sorbitol, stevia, tagatose, thaumatin, xylitol.

Artificial sugar substitutes can be selected but not limited from the group consisting of aspartame, salts of aspartame, cyclamate, dulcin, glucin, neohesperidin dihydrochalcone, saccharin, sucralose.

Hydrogels can be selected but not limited from the group consisting of hydrogel forming polymers like silicone hydrogels, polyacrylamides, cross-linked polymers, polyethylene oxide, polyvinylpyrrolidone, polyvinyl alcohol, sodium polyacrylate, acrylate, or agarose, methylcellulose, hyaluronan, and other naturally derived polymers.

Sulfites

The compositions according to the present disclosure may comprise a sulfite. Sulfites can help to further minimize discoloration in the present compositions. The sulfite may be present at a level of from about 0.001% to about 2.0%, or from about 0.01% to about 0.5%, by weight of the composition.

Suitable sulfites include alkali or alkali earth metal pyrosulfites, sulfites, bisulfites, metasulfites, monoalkyl sulphites, dialkyl sulphites, dialkylene sulphites, or mixtures thereof. Preferably, the sulfite is selected from alkali or alkali earth metal sulfite, bisulfite, or mixtures thereof. Most preferably, the sulfite is potassium sulfite.

Antioxidant

The compositions of the present disclosure may comprise an antioxidant. Antioxidants can help to further minimize discoloration in the present compositions. Antioxidants are substances as described in Kirk-Othmer (Vol. 3, page 424) and in Ullmann's Encyclopedia (Vol. 3, page 91). The compositions of the present disclosure may include an antioxidant, preferably a hindered phenol antioxidant, in an amount of from about 0.001% to about 2%, preferably from about 0.01% to about 0.5%, by weight of the composition.

Suitable antioxidants may include hindered phenols, preferably a hindered phenol selected from the group consisting of: 2,6-bis(1,1-dimethylethyl)-4-methyl-phenol; 2-(1,1-dimethylethyl)-4-methoxyphenol; C₁-C₁₈ linear or branched alkyl esters of 3,5-bis(1,1-dimethylethyl)-4-hydroxy-benzenepropanoic acid; and mixtures thereof. Commercially available antioxidants that may be suitable include BHT (3,5-di-tert-butyl-4-hydroxytoluene), RALOX 35™ (also known as Millishield Pa. 35 and/or 3,5-bis(1,1-dimethylethyl)-4-hydroxy-benzenepropanoic acid, methyl ester) and/or TINOGARD TS™ (3,5-bis(1,1-dimethylethyl)-4-hydroxybenzenepropanoic acid, octadecyl ester).

Structurant

Compact liquid detergent compositions according to the present disclosure may include an external structurant. It has been found that compact liquid detergent compositions that include particles according to the present disclosure may not be physically stable; for example, such compositions may phase separate. It has further been found that external structurants can provide physical stability to liquid compositions according to the present disclosure. External structurants may include non-polymeric crystalline, hydroxy-functional structurants and/or polymeric structurants.

Non-polymeric crystalline, hydroxyl functional structurants may comprise a crystallizable glyceride, which may be pre-emulsified to aid dispersion into the final detergent composition. Suitable crystallizable glycerides include hydrogenated castor oil or “HCO” or derivatives thereof, provided that it is capable of crystallizing in the liquid detergent composition.

Polymeric structurants may include naturally derived structurants and/or synthetic structurants. Naturally derived polymeric structurants include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. The structurant may comprise cellulosic fibers, for example in the form of microfibrillated cellulose. Cellulose may be derived from bacterial, wood, or other plants such as fruit or sugar beet.

Synthetic polymeric structurants include: polycarboxylates, polyacrylates, hydrophobically modified ethoxylated urethanes, hydrophobically modified non-ionic polyols and mixtures thereof. The polycarboxylate polymer may be a polyacrylate, polymethacrylate or mixtures thereof. The polyacrylate may be a copolymer of unsaturated mono- or di-carbonic acid and C₁-C₃₀ alkyl ester of the (meth)acrylic acid. Such copolymers are available from Lubrizol Corp. under the tradename Carbopol® Aqua 30.

Organic Solvent

The compositions of the present disclosure may include solvent, preferably organic solvent, such as a non-aminofunctional organic solvent. Suitable organic solvents may include glycerol, ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof. Organic solvents can provide physical stability benefits, particularly in compact formulations having relatively low water levels. The compositions of the present disclosure may include from about 5% to about 80%, or from about 10% to about 50%, by weight of the composition, of organic solvent.

Additional Aesthetic Agents

The compositions of the present disclosure may include additional aesthetic agents, such as those selected from dyes, opacifiers, pearlescent agents, or mixtures thereof. Suitable dyes may include dyes that are substantially non-substantive to fabrics, hair, and/or other target surfaces for treatment. Suitable opacifiers may include polymers comprising styrene monomers, acrylate monomers, and/or maleate monomers, such as Acusol OP 302 (Styrene-acrylate-divinylbenzene copolymer), Acusol OP 303 (Styrene-acrylamide copolymer) and/or Acusol OP 305 (Styrene/PEG-10 maleate-Nonoxynol-10 maleate/acrylate copolymer), each available from The Dow Chemical Company. Suitable pearlescent agents may include mica, titanium dioxide, coated derivatives of either, monoesters of alkylene glycols, diesters of alkylene glycols, or mixtures thereof. Such aesthetic agents may further help to minimize perception of discoloration that may occur in the compositions.

Water-Soluble Film

When the compact liquid detergent composition is in the form of a unit dose article, such as a pouch or a sachet, the composition may be encapsulated by a water-soluble film.

The water-soluble unit dose article comprises at least one water-soluble film shaped such that the unit-dose article comprises at least one internal compartment surrounded by the water-soluble film. The at least one compartment comprises the detergent composition. The water-soluble film is sealed such that the detergent composition does not leak out of the compartment during storage. However, upon addition of the water-soluble unit dose article to water, the water-soluble film dissolves and releases the contents of the internal compartment into the wash liquor.

The unit dose article may comprise more than one compartment, even at least two compartments, or even at least three compartments, or even at least four compartments, or even at least five compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

The cleaning composition may be a laundry detergent composition, an automatic dishwashing composition, a hard surface cleaning composition or a combination thereof. The cleaning composition may comprise a solid, a liquid or a mixture thereof. The composition may comprise a solid that is suspended in a liquid.

The unit dose article may have a height, a width and a length. The maximum of any of these dimensions is meant to mean the greatest distance between two points on opposite sides of the unit dose article. In other words, the unit dose article may not have straight sides and so may have variable lengths, widths and heights depending on where the measurement is taken. Therefore, the maximum should be measured at any two points that are the furthest apart from each other.

The maximum length may be between 2 cm and 5 cm, or even between 2 cm and 4 cm, or even between 2 cm and 3 cm. The maximum length maybe greater than 2 cm and less than 6 cm. The maximum width may be between 2 cm and 5 cm. The maximum width maybe greater than 3 cm and less than 6 cm. The maximum height may be between 2 cm and 5 cm. The maximum height maybe greater than 2 cm and less than 4 cm. These lengths may be in the presence or absence of the flange.

Preferably, the length:height ratio is from 3:1 to 1:1; or the width:height ratio is from 3:1 to 1:1, or even 2.5:1 to 1:1; or the ratio of length to height is from 3:1 to 1:1 and the ratio of width to height is from 3:1 to 1:1, or even 2.5:1 to 1:1, or a combination thereof. These ratios may be in the presence of absence of a flange.

Each individual unit dose article may have a weight of between 10 g and 40 g, or even between 15 g and 35 g.

The film of the present invention is soluble or dispersible in water (e.g., at 20° C.). Prior to be being formed into a unit dose article, the water-soluble film preferably has a thickness of from 20 to 150 micron, preferably 35 to 125 micron, even more preferably 50 to 110 micron, most preferably about 76 micron.

Preferred film materials are preferably polymeric materials. The film material can, for example, be obtained by casting, blow-moulding, extrusion or blown extrusion of the polymeric material, as known in the art.

Preferably, the water-soluble film comprises polyvinyl alcohol polymer or copolymer, preferably a blend of polyvinylalcohol polymers and/or polyvinylalcohol copolymers, preferably selected from sulphonated and carboxylated anionic polyvinylalcohol copolymers especially carboxylated anionic polyvinylalcohol copolymers, most preferably a blend of a polyvinylalcohol homopolymer and a carboxylated anionic polyvinylalcohol copolymer. Suitable films include those supplied by Monosol under the trade references M8630, M8900, M8779, M8310.

The film may be opaque, transparent or translucent. The film may comprise a printed area. The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 ppm.

### Process of Making

The present disclosure also relates to processes for making feedstock compositions and/or liquid consumer product compositions.

For example, the present disclosure relates to a process for making a liquid consumer product composition, the process comprising the steps of: providing a fragrance material, the fragrance material comprising perfume raw materials that comprise an aldehyde moiety, perfume raw materials that comprise a ketone moiety, perfume raw materials that comprise a phenol moiety, or a mixture thereof; combining the fragrance material with a graft copolymer to form a feedstock composition, the graft copolymer comprising a polyalkylene glycol as a graft base and one or more side chains that comprise vinyl acetate moieties; combining the feedstock composition with a consumer product adjunct to form a liquid consumer product composition, wherein the consumer product composition comprises perfume-delivery particles formed from the fragrance material and the graft copolymer of the feedstock composition.

The process may include combining a graft copolymer according to the present disclosure with a perfume according to the present disclosure and mixing until relatively homogenous. It is believed that by making such a feedstock composition in which the perfume and polymer are well-dispersed, particles can form via self-assembly when the feedstock composition is added to a base composition that includes adjunct material(s). In contrast, as described in more detail in US2018/0072852 (to The Procter & Gamble Company; incorporated herein by reference), it has been found that separately adding graft co-polymer and benefit agents such as perfume to a consumer product composition does not result in the formation of benefit agent delivery particles which comprise graft co-polymer and benefit agent.

The step of premixing the graft copolymer and perfume is preferably achieved by mixing the graft co-polymer and perfume in a mixing device at a rate of from about 500 to about 3000 rpm, preferably from about 600 to about 2500 rpm, and more preferably about 2500 rpm.

The process of combining the graft copolymer and the perfume may further include heating the graft copolymer to a temperature above a melting point of the graft copolymer. The process may include heating the graft co-polymer to at least 45° C. Such heating can facilitate easier mixing.

Solvents, such as aqueous and/or organic solvents, may be added to the polymer if it is initially too viscous to allow for efficient mixing. Water may be utilized in the present processes and resulting compositions (including feedstock compositions and/or consumer product compositions) at levels of less than about 98%, preferably less than about 96%, preferably less than about 90% by weight of the composition, of water. Water can be utilized at levels of from about 1% to about 98%, preferably from about 5% to about 95%, preferably from about 5% to about 90%, preferably from about 5% to about 85%, preferably from about 5% to about 70%, by weight of the composition, of water.

The present disclosure also relates to liquid consumer product composition formed by the processes described herein.

### Process of Treating a Surface

The present disclosure also relates to a process of treating a surface, such as a fabric, hair, and/or skin. The process may include the step of contacting a surface with a compact liquid detergent composition according to the present disclosure.

The contacting step may occur in the presence of water. As described above, it is believed that in the presence of water, the perfume raw materials are released from the graft copolymers. The processes of the present disclosure may include diluting the compact liquid detergent composition with water to form a treatment liquor, which may contact the surface to be treated. The compact liquid detergent composition may be diluted from 100-fold to 1000-fold, or from 200-fold to 900-fold, or from 300-fold to 800-fold, by water.

The contacting step may occur in the drum of an automatic washing machine. The contacting step may occur as a pretreatment step.

### Combinations

Specifically contemplated combinations of the disclosure are herein described in the following lettered paragraphs. These combinations are intended to be illustrative in nature and are not intended to be limiting.

A. A liquid consumer product composition comprising fragrance-delivery particles and a consumer product adjunct, the fragrance-delivery particles comprising a graft copolymer and a fragrance material, the graft copolymer comprising a polyalkylene glycol as a graft base and one or more side chains that comprise vinyl acetate moieties; the fragrance material comprising perfume raw materials that comprise an aldehyde moiety, perfume raw materials that comprise a ketone moiety, perfume raw materials that comprise a phenol moiety, or a mixture thereof.

B. The liquid consumer product composition according to paragraph A, where one or more of the perfume raw materials that comprise an aldehyde moiety, perfume raw materials that comprise a ketone moiety, and/or perfume raw materials that comprise a phenol moiety, further comprise one or more carbon double bonds (C═C) and/or an aromatic ring structure.

C. The liquid consumer product composition according to either of paragraphs A or B, wherein the perfume raw materials that comprise an aldehyde moiety, perfume raw materials that comprise a ketone moiety, perfume raw materials that comprise a phenol moiety, or a mixture thereof that are part of the fragrance-delivery particles are: (a) present in an amount of from about 0.01% to about 5%, or from about 0.02% to about 5%, or from about 0.05% to about 4%, by weight of the composition; and/or (b) present in an amount of from about 1% to about 75%, or from about 2% to about 70%, or from about 3% to about 65%, or from about 4% to about 60%, or from about 10% to about 60%, or from about 20% to about 50%, by weight of the total amount of fragrance material of the particles.

D. A liquid consumer product composition comprising fragrance-delivery particles and a consumer product adjunct, the fragrance-delivery particles comprising a graft copolymer and a fragrance material, the graft copolymer comprising a polyalkylene glycol as a graft base and one or more side chains that comprise vinyl acetate moieties; the fragrance material comprising a perfume raw material selected from: 2,6,10-trimethyl-9-undecenal; amyl cinnamic aldehyde; anisaldehyde; citral; citronellal; cyclal c; cyclamen aldehyde; ethyl vanillin; floralozone; helional; heliotropin; hexyl cinnamic aldehyde; lilial; myrac aldehyde; phenyl acetaldehyde; triplal; undecylenic aldehyde; vanillin; alpha-ionone; beta-ionone; laevo carvone; alpha damascone; delta damascone; iso e super; methyl ionone; eugenol; or mixtures thereof.

E. The liquid consumer product composition according to paragraph D, wherein the perfume raw materials are: (a) present in an amount of from about 0.01% to about 5%, or from about 0.02% to about 5%, or from about 0.05% to about 4%, by weight of the composition; and/or (b) present in an amount of from about 1% to about 75%, or from about 2% to about 70%, or from about 3% to about 65%, or from about 4% to about 60%, or from about 10% to about 60%, or from about 20% to about 50%, by weight of the total amount of fragrance material of the particles.

F. The liquid consumer product composition according to any of paragraphs A-E, wherein the polyalkylene glycol of the graft copolymer comprises polyethylene glycol (“PEG”), preferably a polyethylene glycol having a weight average molecular weight from about 2000 to about 15,000 Daltons, or from about 4000 to about 12,000 Daltons, or from about 6000 to about 12,000 Daltons.

G. The liquid consumer product composition according to any of paragraphs A-F, wherein the graft copolymer comprises from about 1 to about 10 side chains per graft base.

H. The liquid consumer product composition according to any of paragraphs A-G, wherein the graft copolymer is characterized by a weight ratio of polyalkylene glycol, preferably polyethylene glycol, to vinyl acetate moieties of about 5:1 to about 1:10, preferably from about 3:1 to about 1:8, more preferably from about 2:1 to about 1:6.

I. The liquid consumer product composition according to any of paragraphs A-H, wherein the graft copolymer is characterized by a weight-average molecular weight of from about 2000 Daltons to about 250,000 Daltons, preferably from about 3000 Daltons to about 100,000 Daltons, more preferably 4,000 Daltons to about 50,000 Daltons, most preferably from about 5,000 to about 20,000 Daltons.

J. The liquid consumer product composition according to any of paragraphs A-I, wherein the fragrance-delivery particles are characterized by a number-average diameter of from about 0.5 microns to about 5000 microns, preferably from about 0.5 microns to about 1000 microns, more preferably from about 0.5 microns to about 250 microns, most preferably from about 1 microns to about 60 microns.

K. The liquid consumer product composition according to any of paragraphs A-J, wherein the composition comprises less than 50 wt %, or less than 40 wt %, or less than 30 wt %, or less than 20 wt %, or less than 15 wt %, or less than 12 wt %, or less than 10 wt %, by weight of the composition, of free water.

L. The liquid consumer product composition according to any of paragraphs A-K, wherein the consumer product adjunct comprises an amine, a surfactant system, a water-binding agent, a sulfite, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, free perfume, structure elasticizing agents, fabric softeners, carriers, fillers, hydrotropes, organic solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

M. The liquid consumer product composition according to any of paragraphs A-L, wherein the consumer product adjunct comprises a surfactant system present in an amount of from about 20% to about 75%, by weight of the composition.

N. The liquid consumer product composition of paragraph M, wherein the surfactant system is characterized by at least one of the following: a) the surfactant system comprises from about 2% to about 15%, or from about 4% to about 12%, by weight of the composition, of nonionic surfactant, preferably an ethoxylated alcohol; b) the surfactant system comprises from about 0% to about 8%, or from about 1% to about 6%, by weight of the composition, of linear alkyl benzene sulphonate (LAS); c) the total amount of nonionic surfactant and LAS present in the surfactant system comprises from about 4% to about 15%, or from about 6% to about 12%, by weight of the composition; d) the weight ratio of nonionic surfactant to LAS is from about 1:3 to about 1:0, or from about 1:1 to about 15:1.

O. The liquid consumer product composition according to any of paragraphs A-N, wherein the consumer product adjunct comprises an amine, preferably an alkanolamine, an amine-containing polymer, an oligoamine, or a mixture thereof.

P. The liquid consumer product composition according to any of paragraphs A-O, wherein the consumer product adjunct comprises an alkanolamine, preferably an alkanolamine selected from the group consisting of monoalkanolamine, dialkanolamine, trialkanolamine, or mixtures thereof, more preferably selected from the group consisting of monoethanolamine, diethanolamine, triethanolamine, or mixtures thereof.

Q. The liquid consumer product composition according to any of paragraphs A-P, wherein the consumer product adjunct comprises a water binding agent, preferably selected from organic acids, salts of organic acids, humectants, desiccants, natural sugar substitutes, artificial sugar substitutes, hydrogels, or mixtures thereof.

R. The liquid consumer product composition according to any of paragraphs A-Q, wherein the consumer product adjunct comprises a sulfite.

S. The liquid consumer product composition according to any of paragraphs A-R, wherein the composition is a fabric care composition, a hard surface cleaner composition, a dish care composition, a hair care composition, a body cleansing composition, or a mixture thereof.

T. The liquid consumer product composition according to any of paragraphs A-S, wherein the composition is encapsulated in a water-soluble film.

U. A process for making a liquid consumer product composition, the process comprising the steps of: providing a fragrance material, the fragrance material comprising perfume raw materials that comprise an aldehyde moiety, perfume raw materials that comprise a ketone moiety, perfume raw materials that comprise a phenol moiety, or a mixture thereof; combining the fragrance material with a graft copolymer to form a feedstock composition, the graft copolymer comprising a polyalkylene glycol as a graft base and one or more side chains that comprise vinyl acetate moieties; combining the feedstock composition with a consumer product adjunct to form a liquid consumer product composition, wherein the consumer product composition comprises perfume-delivery particles formed from the fragrance material and the graft copolymer of the feedstock composition.

V. The liquid consumer product composition formed by the process according to paragraph U, preferably wherein the liquid consumer composition is according to any of paragraphs A-T.

W. A process of treating a surface, the process comprising the step of contacting the surface with the consumer product composition according to any of paragraphs A-T or V.

### Test Methods

It is understood that the test methods that are disclosed in the Test Methods Section of the present application should be used to determine the respective values of the parameters of Applicant's invention as such invention is described and claimed herein.

### 1. Number-Weighted Average Diameter and Structure Test Method

Microscopy is used to measure the number-weighted average diameter (or simply “diameter” as used herein) of the co-polymer particles. Microscopy is also used to determine the structure of the particles via observing the frequency and the location of benefit agent regions in the particles. The microscopic measurement particle diameter may be conducted using any microscopic technique capable of imaging the external size of the particles in the sample. The microscopic determination of structure may be conducted using any microscopic technique capable of imaging the internal presence and location of the benefit agent regions in the particles. Suitable microscopy techniques may include but are not limited to: Scanning Electron Microscopy (SEM); Phase Contrast Microscopy; Differential Interference Contrast microscopy (DIC); Fluorescence Microscopy; and Confocal Laser Scanning Fluorescence Microscopy (CLSM). One of skill will understand that different and various sample preparation steps may be required for the different imaging techniques which may be suitable. In all cases, the number-weighted average diameter of the particles is calculated from the values obtained by microscopically observing and measuring the diameter of at least 30 randomly selected particles in a sample.

The structure of the particles is assessed by microscopically observing and determining the frequencies and locations of all observable benefit agent regions in at least 30 randomly selected particles in a sample. In the case of optical light microscopy techniques it is suitable to use a high magnification water-immersion objective lens such as a 63×/1.2 NA Water lens (Zeiss) to observe 0.5 mL of sample placed into a Chambered Coverglass such as Chambered #1.0 Borosilicate Coverglass System (such as from LabTek) and to dilute the sample as necessary to obtain unobstructed images of the particle diameter and structure. In the case of fluorescence microscopy and especially fluorescence confocal laser scanning microsopy (CLSM), the selective labeling of the polymers and the benefit agents with different fluorescent dyes can enable their separate detection via excitation with different wavelengths of light. For example, by labeling the polymer(s) with a red dye label such as Rhodamine isothiocyanate (λex=561 nm), and the benefit agents with a dye probe having a different excitation wavelength, for example such as Coumarin 6 (λex=488 nm), it is then possible to determine where the polymer and the benefit agents are located by means of different filters and detectors on the microscope. By using the overlay of images from the different detectors it is possible to identify the regions of co-localization, and observe the frequency and spatial location of the benefit agent regions relative to the particle and its polymer regions.

### 2. Free Water Content Test Method

Free water content (FWC) refers to the amount of freezable non-bound water with a temperature of fusion around 0° C. and is defined as:

$$FWC \% = ( \frac{Δ {H}_{f , sample} * {m}_{sample}}{Δ {H}_{f , {H}_{2} O}} ) / {m}_{s a m p l e} * 100$$

where ΔH_{f,sample} is the enthalpy of fusion of water in the sample in J/g, mₛₐₘₚₗₑ is the weight of the sample in g, and ΔH_{f,H2O} is the enthalpy of fusion of pure water in J/g.

### 1. Materials

Differential scanning calorimetry with refrigerated cooling system, such as DSC-Q2000 with DSC software Advantage for Q series version 5.4.0, and Analysis software such as Universal analysis 2000 version 4.5A (TA instruments), or equivalents.
Analytical balance (sensitivity 0.0001 g), such as Sartorius CP225D.
DSC Steel pan, such as Perkin Elmer model: 0319-1525 (bottom) 0319-1526 (cover) 0319-1535 (O-ring)

2. Procedure to measure ΔH_{f,sample}
1) Weight on the balance the Steel pan with its cover and the O-ring. Note the weight (Wₚ)
2) Assemble the O-ring with the cover
3) Weight on the balance the amount of sample (10-20 mg) added into the pan, note the weight (Wₛ₊ₚ)
4) Close the pan hermetically
5) Calculate Wₛ=Wₛ₊ₚ−Wₚ
6) Insert the pan in the DSC
7) Open the Nitrogen line (flow must be not below 50 ml/min)
8) Open the software TA instrument explorer
9) Turn on the cooler from the button control and then press “event on” on the software
10) The software is subdivided into three main parts. (Summary-procedure-notes). In summary you have to write the details of the sample (sample name, Wₚ, Wₛ) and the type of pan you are using, then select the directory to save the data and flag “pan mass”. In the ‘Procedure’ panel by pressing ‘Editor’ you can write down the procedure needed for your samples. Here we report the procedure used to calculate the FWC.
   Equilibrate at 5° C.
   Data storage on
   Ramp 0.5°/min to −80° C.
   Mark the end of the cycle “0”
   Ramp 0.5° C./min to 25° C.
   Mark the end of the cycle “1”
      In the ‘notes’ panel choose the appropriate calibration in this case (Steel pan 0.5° C./min)
11) Press ‘apply’ button to complete the run procedure and start from the main software panel.
12) Once the run is done it will be green flagged

3. Procedure to Analyze the Data
1) Open the data collected with the DSC, using the analysis software (Universal analysis 2000 version 4.5A)
2) Expand the region of interests (typically between −20 and +5° C.)
3) Click on “Integrate Peak Linear”
4) Double-click before and after the thermal peak to insert two cursors that determine the integration limits
5) Right-click in between the two cursors and click on “accept limits”
6) The software calculates ΔH_{f,sample} in J/g

4. Determination of ΔH_{f,H2O}

Instead of using the standard value of 333.55 J/g as ΔH_{f,H2O}, one can calculate ΔH_{f,H2O} for the instrument used (the value should be comprised between 333.55±30 J/g).

Three samples of 1-2 mg of deionized water (such as MilliQ grade, 18.2 MΩ cm) each are precisely weighted in a DSC steel pan (take note of the precise weight) and placed in a DSC. All samples are analyzed using the same procedure used to determine ΔH_{f,sample} described. Once determined ΔH_{f,sample}, ΔH_{f,H2O}, one can calculate the FWC.

### 3. Weight-Average Molecular Weight Test Method

Weight-average molecular weight values are determined using high performance liquid chromatography (HPLC) instrument system with a refractive index detector, such as the Waters Alliance 2695 system equipped with autosampler and Waters 2414 refractive index detector (Waters Inc., Milford, Mass., USA). Data storage and analysis are performed with Astra 6.1.6 software (Wyatt Technologies, Santa Barbara, Calif., USA). The chromatographic conditions used are as specified in the table below:

| Parameter | Conditions | |
|---|---|---|
| Column Set | Guard Column-TSK Gel Guard | |
| | HXL-H in-line with | |
| | Three TOSOH columns: | |
| | TSK Gel G4000HXL | |
| | Catalog #0016137; | |
| | TSK Gel G5000HXL | |
| | Catalog #0016138; | |
| | TSK Gel G6000HXL | |
| | Catalog #0016139; | |
| Mobile Phase | Tetrahydrofuran (THF) | |
| Flow Rate | 1 | mL/min |
| Column Temperature | 25° C. | |
| Injection Volume | 100 | μL |

| | |
|---|---|
| Detector Temperature | 35° C. |

In carrying out the calculations, the results are calibrated using a set of 12 polystyrene reference samples, such as the EasiVial PS-M set (Agilent Technologies, Santa Clara, Calif.) having known molecular weights ranging from 162 to 364,000 Mₚ and using a second order fit. The molecular weight analyses are determined using a tetrahydrofuran (THF) mobile phase. The table below shows the molecular weights and the retention times of the polystyrene standards:

| | Average | Retention |
|---|---|---|
| Standard | Reported | Time |
| Number | Mp | (min) |
| 1 | 364,000 | 21.75 |
| 2 | 195,300 | 23.02 |
| 3 | 110,500 | 24.18 |
| 4 | 49,010 | 25.78 |
| 5 | 30,230 | 26.61 |
| 6 | 12,980 | 27.90 |
| 7 | 7,640 | 28.60 |
| 8 | 2,970 | 29.71 |
| 9 | 1,150 | 30.79 |
| 10 | 855 | 31.10 |
| 11 | 370 | 31.91 |
| 12 | 162 | 32.95 |

### 4. Grafting and Ratio of Polyalkylene Glycol: Vinyl Acetate Moieties Test Methods

The percent grafting is determined by 13C-NMR using a Bruker 600 MHz NMR. An inverse-gated 30° pulse sequence is used, with 16,000 scans and relaxation delay of 5 sec. Samples are prepared at 50 mg/ml in deuterated DMSO-d6 with addition of 0.79 mg/ml Gd(NO₃)₃ and 0.31 mg/ml Inositol as a Paramagnetic Relaxation Reagent. The ratio of the integration of the area between 76.75-77.5 ppm for the graft methine carbon and the integration of the area between 70.00-70.65 ppm for the PEG carbons is calculated and converted to a percent.

The weight percents for Polyalkylene Glycol: Vinyl Acetate Moieties are calculated by averaging the integration of the area of the NMR proton spectra between 1.35-2.07 ppm & 4.65-5.1 ppm for polyvinyl acetate and 3.38-3.58 ppm for Polyalkylene Glycol. The integrations are divided to find a molar ratio, and then multiplied by their respective molar mass to calculate the weight percents.

### 5. Method of Measuring Viscosity

Viscosity is measured using a HAAKE MARS from Thermo Scientific using a 60 mm 1° Cone and a gap size of 52 micrometers. The shear viscosity at 205⁻¹ can be obtained from a logarithmic shear rate sweep from 0.01 s⁻¹ to 1200 s⁻¹ at 21° C. The viscosity may be expressed as centipoise (cP).

### 6. Color Difference Determination (ΔE)

To measure the color difference between two liquid compositions, a delta-E (ΔE) value can be determined according to the following procedure.

Vis spectra for test samples and reference samples may be collected at desired time intervals, for example when prepared (fresh, or time=0) and/or after 28 days of storage.

To measure the color differences, turn on the UV/Vis spectrometer and open the instrument control software. Insert an empty cuvette in the sample location inside the instrument. Click on “Zero” and wait until the procedure is completed. Click on File/Setup. In the ‘Scan’ panel choose 700-400 nm scan range, 1 nm for data interval, and 0.1 s for Average time, then press “OK”. Press “START” in the software main window. Generate directories for both Methods and Data and then press “OK”. Wait until the spectrum is collected. Save spectra for samples and references in the .CSV format. Click on File/Open Data and select the sample spectrum. Click on File/Setup. In the ‘Illuminants and Observer’ setup choose “CIE D65” as Illuminant and “2 degrees” as Observer. In the ‘Color Space’ panel choose “CIE Lab” as color space. In the ‘Color Differences’ panel choose DeltaE as color difference, then click on “Standard File” and then browse and select the reference spectrum (either polymer or perfume reference sample); press “Ok”. The instrument calculates and prints the DeltaE value between the selected sample and reference. Record this value.

### EXAMPLES

The examples provided below are intended to be illustrative in nature and are not intended to be limiting.

### Example 1. Exemplary Graft Copolymers

Graft copolymers according to the present disclosure may be made according to the following general procedure: A reaction vessel with stirrer and reflux condenser is charged with the initial PEG under a nitrogen atmosphere and melted at the reaction temperature. After addition of the initial charges of vinyl acetate (freshly distilled) and t-butyl peroxypivalate initiator (dissolved in the initial dipropylene glycol), the contents are stirred for 5 minutes. To the vessel, simultaneously with constant flow rate, is metered the vinyl acetate feed (freshly distilled) over 6 hours, and t-butyl peroxypivalate initiator feed 1 (dissolved in dipropylene glycol) over 7 hours. The internal temperature is maintained at the reaction temperature with stirring throughout. After initiator feed 1 is finished the mixture is stirred at the reaction temperature for 1 hour. Then at the reaction temperature, t-butyl peroxypivalate initiator feed 2 (dissolved in dipropylene glycol) is added. One hour later t-butyl peroxypivalate initiator feed 3 (dissolved in dipropylene glycol) is added. The reaction is stirred at the reaction temperature for 4 hours. The reaction mixture is vacuum distilled at 90° C. to remove residual vinyl acetate.

Table 1 shows exemplary polyethylene glycol (PEG)/polyvinyl acetate (PVAc) graft copolymers that may be suitable for the present compositions.

TABLE 1

| Sample | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| MW | 10.3 | 11.05 | 13.05 | 14.65 | 5.95 | 6.2 | 5.7 | 5.6 | 7.7 | 10.2 |
| (kDa) | | | | | | | | | | |
| MW of | 6000 | 6000 | 12000 | 12000 | 12000 | 12000 | 6000 | 6000 | 2000 | 2000 |
| parent | | | | | | | | | | |
| PEG | | | | | | | | | | |
| (Da) | | | | | | | | | | |
| wt % | 29 | 31 | 34 | 30 | 70 | 72 | 72 | 79 | 30 | 30 |
| PEG | | | | | | | | | | |
| wt % | 71 | 69 | 66 | 70 | 30 | 28 | 28 | 21 | 70 | 70 |
| PVAc | | | | | | | | | | |
| % | 0.80% | 4.41% | 2.55% | 0.21% | 0.28% | 1.26% | 0.52% | 0.80% | 3.75% | 5.83% |
| PEO | | | | | | | | | | |
| units | | | | | | | | | | |
| grafted | | | | | | | | | | |

### Example 2. Exemplary Perfumes

An illustrative perfume formulation according to the present disclosure is provided below in Table 2A. Certain perfume raw materials are labeled as being aldehydes, ketones, or phenols. Perfume raw materials that are particularly likely to lead to discoloration when present at the provided levels are marked with an asterisk (*).

TABLE 2A

| Material | Wt % | Type |
|---|---|---|
| Amber Xtreme | 0.0473% | |
| ISOAMYL BUTYRATE | 0.0947% | |
| Spirogalbanone Pure | 0.0947% | ketone |
| HEXYL ISOBUTYRATE | 0.2367% | |
| OCTAHYDRO COUMARIN | 0.2367% | |
| ETHYL VANILLIN * | 0.2367% | aldehyde; |
| | | phenol |
| EUGENOL * | 0.2841% | phenol |
| ISO BUTAVAN | 0.2841% | aldehyde |
| NONALACTONE | 0.2841% | |
| ETHYL CINNAMATE | 0.4735% | |
| METHYL PHENYL CARBINYL | 0.4735% | |
| ACETATE | | |
| NIRVANOL | 0.4735% | |
| CIS 3 HEXENYL ACETATE | 0.5682% | |
| DELTA MUSCENONE | 0.5682% | ketone |
| METHYL NONYL ACETALDEHYDE | 0.6629% | aldehyde |
| ALLYL CYCLOHEXANE PROPIONATE | 0.6629% | |
| AMBRONAT | 0.9470% | |
| TRIMOFIX O | 0.9470% | ketone |
| DELTA DAMASCONE * | 1.1364% | ketone |
| ETHYL-2-METHYL BUTYRATE | 1.3258% | |
| VERTOCITRAL * | 1.8939% | aldehyde |
| FIF/UL Lorysia | 2.3674% | |
| METHYL DIHYDRO JASMONATE | 2.3674% | |
| UNDECAVERTOL | 1.8939% | |
| MAYOL | 1.8939% | |
| IONONE ALPHA * | 2.8409% | ketone |
| PINYL ISOBUTYRALD ALPHA | 3.7879% | aldehyde |
| CIS-3-HEXENYL SALICYLATE | 1.8939% | |
| IONONE GAMMA METHYL * | 3.7879% | ketone |
| VERDOX | 4.7348% | |
| NECTARYL | 7.5000% | ketone |
| UNDECALACTONE | 7.5000% | |
| LYRAL * | 9.5000% | aldehyde |
| ISO E SUPER OR WOOD | 11.0000% | ketone |
| FRUTENE | 12.0000% | |
| HEXYL SALICYLATE | 15.0000% | |
| TOTALS: | 100.0% | |

Table 2B shows various perfumes (PERF1, PERF2 . . . ) that include perfume raw materials. The weight percentages of aldehydes, ketone, and phenol perfume raw materials are provided. Character descriptions are provided for several of the perfumes.

TABLE 2B

| Perfume | Character | Aldehydes | | Ketones | | Phenols | |
|---|---|---|---|---|---|---|---|
| PERF1 | — | 15.9 | wt % | 27.8 | wt % | 1.5 | wt % |
| PERF2 | — | 11.3 | wt % | 27.2 | wt % | 0.9 | wt % |
| PERF3 | — | 20 | wt % | 8 | wt % | 12 | wt % |
| PERF4 | Floral, | 6.8 | wt % | 15.6 | wt % | 0.01 | wt % |
| | powdery | | | | | | |
| PERF5 | Fruity, sweet | 9 | wt % | 9 | wt % | 4.8 | wt % |
| PERF6 | Citrus, floral | 17.8 | wt % | 19.6 | wt % | 2.1 | wt % |

musky

### Example 3. Preparation of Polymer/Perfume Premix

A polymer/perfume premix may be prepared according to the following procedure. Weigh about 1 g of PEG-g-PVAc copolymer into a glass vial, and screw on the cap. Set a EchoTherm™ block heater at 80° C. and wait until the polymer is melted. Place the vial on a balance and add the perfume to be encapsulated in the desired amount; the perfume level may be, for example, from about 10% to about 50% of the total polymer/perfume mixture. Mix with a Stuart SA8 vortex mixer (Bibby Scientific, Staffordshire, UK) at 2500 rpm until a homogeneous viscous liquid is obtained.

Exemplary polymer/perfume premixes are provided below in Table 3. With regard to the identity of the graft copolymers, POLY1 is a polymer according to Ex. 4 in Example 1 above (30:70 wt ratio of PEG12000:PVAc); POLY2 is characterized by a 40:60 wt ratio of PEG6000:PVAc (calculated molecular weight of about 15,000 Daltons, based on 40 wt % PEG6000). Descriptions of the perfumes (PERF1, PERF2, etc.) are provided according to Table 2B in Example 2 above.

The percentages provided below are weight percentages, by weight of the polymer/perfume mixture.

TABLE 3

| MIX | Polymer (wt %) | | Perfume (wt %) | | | | | |
|---|---|---|---|---|---|---|---|---|
| # | POLY1 | POLY2 | PERF1 | PERF2 | PERF3 | PERF4 | PERF5 | PERF6 |
| MIX1 | 75 | | 25 | | | | | |
| MIX2 | 75 | | | 25 | | | | |
| MIX3 | 90 | | | | 10 | | | |
| MIX4 | | 90 | | | 10 | | | |
| MIX5 | 75 | | | | 25 | | | |
| MIX6 | | 75 | | | 25 | | | |
| MIX7 | 50 | | | | | 50 | | |
| MIX8 | | 50 | | | | 50 | | |
| MIX9 | 50 | | | | | | 50 | |
| MIX10 | | 50 | | | | | 50 | |
| MIX 11 | | 50 | | | | | | 50 |

### Example 4. Preparation of a Liquid Consumer Product Composition (e.g., a Liquid Detergent)

To prepare test samples, combine a polymer/perfume premix with a base detergent formulation in a vial. Vortex with Stuart SA8 vortex mixer at 600 rpm to disperse the premix in the detergent matrix, then transfer into a disposable cuvette filling the volume as much as possible (about 1.5 g of sample), cover the cuvette with PVA film, and secure the film to the cuvette with adhesive tape. All samples are kept at temperatures between 25 and 40° C.

Reference samples may be similarly prepared, but in such cases, the polymer and the perfume are separately added to the base detergent formulation (e.g., no polymer/perfume premix). However, the materials are added in such amounts so that the level of perfume and/or polymer in a given test sample and a given reference sample are the same.

For example, 3.3 parts of MIX11 may be added to 96.7 parts of a base detergent formulation. Because the premix is 50/50 polymer/perfume, the resulting composition will include 1.65 wt % of polymer and 1.65 wt % of perfume. A comparative reference sample may be obtained by adding 1.65 parts polymer and 1.65 parts perfume to 96.7 parts of the base detergent. Based on past experiments, it is believed that the composition formed with the premix will include self-assembled particles that include the polymer and the perfume. When the polymer and the perfume are added separately, the particles do not form.

In other cases, a fresh sample, made with a polymer/perfume premix, may be used as a reference sample for comparisons to test samples that have been stored/aged.

Suitable base detergent formulations (FORM1, FORM2, and FORM3) are provided below in Table 4. One or more of these base detergent formulations are used in subsequent examples.

TABLE 4

| | FORM 1 | FORM 2 | FORM 3 |
|---|---|---|---|
| | (wt %) | (wt %) | (wt %) |
| dodecyl benzene sulphonic acid | 27.25% | 23.41% | 23.41% |
| anionic alkyl ethoxylate | 18.97% | 16.05% | 16.05% |
| ethoxylated alcohol | 3.73% | 4.08% | 4.08% |
| lauric fatty acid | 7.67% | 6.53% | 6.53% |
| citric acid | 1.10% | 0.77% | 0.77% |
| 1.2-propanediol | 9.95% | 11.36% | 10.53% |
| dipropylene glycol | 4.85% | 4.10% | 4.10% |
| monoethanolamine | 9.95% | 11.09% | 11.09% |
| glycerine | 4.87% | 4.12% | 4.12% |
| 1-hydroxyethane-1, | — | 2.47% | 2.47% |
| 1-diphosphonic acid | | | |
| antifoam | — | 0.30% | 0.30% |
| enzymes | — | 0.08% | 0.08% |
| structurant | — | 0.09% | 0.09% |
| optical brightener | 0.02% | 0.39% | 0.39% |
| bicarbonate | — | 0.09% | 0.09% |
| sodium formate | — | 0.10% | 0.10% |
| calcium formate | 0.10% | — | — |
| sorbitol | — | 0.05% | 0.05% |
| magnesium chloride | — | 0.35% | 0.35% |
| sodium hydroxide | 0.02% | — | — |
| sodium bisulfite | 0.06% | — | — |
| potassium sulfite | — | — | 0.40% |
| polyethylene imine and | 4.14% | 3.50% | 3.50% |
| ethylene oxide copolymer | | | |
| pentetic acid | 1.10% | — | — |
| water (and minors) | balance | balance | balance |

### Example 5. Effect of Polymer/Perfume Premix on Composition Discoloration

For this example, two of the polymer/perfume mixtures (MIX1 and MIX2) provided above are separately combined with a base detergent formulation (FORM1). MIX1 includes PERF1, which contains about 25 wt % of perfume raw materials that are typically associated with discoloration. MIX2 includes PERF2, which has a similar composition as PERF1, but without the particular discoloring perfume materials. Based on experience, it is expected that a composition comprising PERF1 would show more discoloration upon storage than a composition comprising PERF2.

The resulting product compositions are stored for 21 days at about 25° C., after which they are assessed for color differences (ΔE, according to the method provided above) compared to a reference composition (REF=a fresh sample of the composition), thereby giving an indication of how much each composition discolored over the course of storage. Results are provided in Table 5 below.

TABLE 5

| | Base | Polymer/ | | |
|---|---|---|---|---|
| | Detergent | Perfume | Storage | |
| | Formulation | Mixture | Conditions | |
| Trial | (%) | (%) | (Temp./Time) | ΔE vs. REF |
| 1 | FORM1 (90%) | MIX1 (10%) | 25° C./21 days | 5.3 ± 1.0 |
| 2 | FORM1 (90%) | MIX2 (10%) | 25° C./21 days | 5.4 ± 1.0 |

The samples in both trials experienced relatively low levels of discoloration upon storage when compared to a fresh sample (REF). (It is believed that a ΔE of 5 or greater is the approximate threshold where a color change becomes noticeable.) These low levels of discoloration provide evidence of particle formation and/or protection of the perfumes.

Furthermore, as shown in Table 5, the composition of Trial 1, which includes certain raw materials known to discolor, shows a very similar ΔE upon storage to the composition of Trial 2, which does not include the discoloring PRMs. These results indicate that by providing the discoloring perfume of Trial 1 as part of a polymer/perfume mixture according to the present disclosure (and thus, forming particles in the composition), undesirable discoloration is at least slowed to levels that are comparable to relatively non-discoloring perfumes.

### Example 6. Effect of Polymer Selection and Perfume Levels on Discoloration

For this example, three of the polymer/perfume mixtures (MIX3, MIX4, and MIX5) provided above are separately combined with a base detergent formulation (FORM2).

Each of Trials 3, 4, and 5 include premixes that include PERF3, which contains about 10 wt % (by weight of PERF3) of perfume raw materials that are typically associated with discoloration. Trials 3 and 4 include different graft copolymers in the premix; MIX3 includes polymer POLY1, and MIX4 includes polymer POLY2. Trials 3 and 5 include different amounts of perfume in the premix; MIX5 includes a higher amount of PERF3 (25 wt %) than does MIX3 (10 wt % of PERF3).

The resulting product compositions are stored for 28 days at about 37° C., after which they are assessed for color differences (ΔE, according to the method provided above) compared to reference compositions. For the reference compositions of this example, equivalent amounts of perfume or polymer are added to the base detergent formulation and then stored under similar time/temperature conditions. For example, for Trial 3, REF1 contained 1% of PERF3, and REF2 contained 9% of polymer POLY1. Results are provided in Table 6 below.

TABLE 6

| | | Polymer/ | | | |
|---|---|---|---|---|---|
| | | Perfume | | | |
| | Base | Mixture (%) | Storage | ΔE vs. | ΔE vs. |
| | Detergent | [total perfume | Conditions | REF1 | REF2 |
| | Formulation | in trial, | (Temp./ | (vs. neat | (vs. |
| Trial | (%) | as wt %] | Time) | perfume) | polymer) |
| 3 | FORM2 | MIX3 (10%) | 37° C./ | 32.7 ± 1.0 | 5.9 ± 1.0 |
| | (90%) | [1%] | 28 days | | |
| 4 | FORM2 | MIX4 (10%) | 37° C./ | 25.1 ± 1.0 | 8.3 ± 1.0 |
| | (90%) | [1%] | 28 days | | |
| 5 | FORM2 | MIX5 (10%) | 37° C./ | 21.6 ± 1.0 | 7.7 ± 1.0 |
| | (90%) | [2.5%] | 28 days | | |

Although not shown in Table 6, the REF1 compositions of Trials 3, 4, and 5 showed more discoloration compared to a fresh sample than did the test compositions of Trials 3, 4, and 5; in other words, the test compositions having particles according to the present disclosure stayed truer to the original color.

Furthermore, as shown in Table 6, the compositions of Trials 3, 4, and 5 show a high ΔE when compared to REF1 references, indicating that the encapsulating action of the polymer prevents the perfume from leaking into the matrix, which might otherwise lead to discoloration. Trials 3 and 5 indicate that the encapsulating action of the polymer mitigates discoloration when the perfume is present at different levels.

In addition, the low ΔE values obtained when comparing Trials 3, 4, and 5 to the REF2 references (polymer-only formulations, with no perfume present) indicate that the color changes are largely due to the discoloring effect of the perfume.

Additionally, the ΔE vs REF2 value for Trial 4 is lower than that of Trial 5, which indicates that polymer POLY1 shows a higher stability with respect to polymer POLY2 upon aging. These results indicate that different polymers can be used in the polymer/perfume mixture according to the present disclosure, to prevent/slow undesirable discoloration, with POLY1 being more effective than POLY2 upon storage/aging.

### Example 7. Effect of Sulfite on Discoloration

For this example, one of the polymer/perfume mixtures (MIX5) is separately combined in two base detergent mixtures (FORM2 and FORM 3). The two detergent mixtures differ in the absence (FORM2) or presence (FORM3) of sulfite, an agent that is known to reduce the discoloring effect. MIX5 includes PERF3, which contains about 10 wt % of perfume raw materials that are typically associated with discoloration.

The resulting product compositions are stored for 28 days at about 37° C., after which they are assessed for color differences (ΔE, according to the method provided above) compared to a reference composition. For the reference compositions of this example, equivalent amounts of perfume (REF1) or polymer (REF2) are added to the base detergent formulation and then stored under similar time/temperature conditions. Results are provided in Table 7 below.

TABLE 7

| | Base | Polymer/ | Storage | ΔE vs. | ΔE vs. |
|---|---|---|---|---|---|
| | Detergent | Perfume | Conditions | REF1 | REF2 |
| | Formulation | Mixture | (Temp./ | (vs. neat | (vs. |
| Trial | (%) | (%) | Time) | perfume) | polymer) |
| 6 | FORM2 | MIX5 | 37° C./ | 31.1 ± 1.0 | 7.7 ± 1.0 |
| | (90%) | (10%) | 28 days | | |
| | (nil-sulfite) | | | | |
| 7 | FORM3 | MIX5 | 37° C./ | 21.5 ± 1.0 | 5.2 ± 1.0 |
| | (90%) | (10%) | 28 days | | |
| | (with sulfite) | | | | |

As shown in Table 7, the compositions of both Trial 6 and Trial 7 show a high ΔE when compared to REF1 references, which indicate that the encapsulating action of the polymer prevents the perfume from leaking and slow or no discoloration occurs even in the absence of sulfites. Again, low ΔE values are obtained when comparing Trial 6 and Trial 7 to REF2 references, that is polymer-only in formulations, indicating that the possible color changes are mainly due to the discoloring effect of the perfume.

The ΔE vs both REF1 and REF2 for Trial 6 is higher than that of Trial 7, which indicates that the presence of sulfites in the detergent formulations still helps in slowing/avoiding discoloration. These results indicate that the polymer/perfume mixture according to the present disclosure can be used in detergent formulation that do or do not contain sulfites to prevent/slow undesirable discoloration. Furthermore, the presence of sulfites in these compositions can further slow discoloration.

### Example 8. Effect of Time and Temperature on Discoloration

For this example, one of the polymer/perfume mixtures (MIX3) is combined in a base detergent mixture (FORM2). The colorimetry measurements are collected at two different time intervals (Trials 8 and 9: 14 and 28 days, respectively) and at two different temperatures (Trials 10 and 11: 25° C. and 37° C., respectively). MIX3 includes PERF3, which contains about 10 wt % of perfume raw materials that are typically associated with discoloration.

After storage at the indicated conditions, the compositions are assessed for color differences compared to reference compositions. For the reference compositions of this example, equivalent amounts of perfume (REF1) or polymer (REF2) are added to the base detergent formulation and then stored under similar time/temperature conditions. Results are provided in Table 8 below.

TABLE 8

| | Base | Polymer/ | Storage | ΔE vs. | ΔE vs. |
|---|---|---|---|---|---|
| | Detergent | Perfume | Conditions | REF1 | REF2 |
| | Formulation | Mixture | (Temp./ | (vs. neat | (vs. |
| Trial | (%) | (%) | Time) | perfume) | polymer) |
| 8 | FORM2 | MIX3 | 37° C./ | 19.2 ± 1.0 | 2.2 ± 1.0 |
| | (90%) | (10%) | 14 days | | |
| 9 | FORM2 | MIX3 | 37° C./ | 25.1 ± 1.0 | 5.9 ± 1.0 |
| | (90%) | (10%) | 28 days | | |
| 10 | FORM2 | MIX3 | 25° C./ | 30.3 ± 1.0 | 2.5 ± 1.0 |
| | (90%) | (10%) | 28 days | | |
| 11 | FORM2 | MIX3 | 37° C./ | 32.7 ± 1.0 | 5.9 ± 1.0 |
| | (90%) | (10%) | 28 days | | |

As shown in Table 8, the composition of both Trial 8 and Trial 9, show a high ΔE when compared to REF1 references, which indicate that the encapsulating action of the polymer prevents the perfume from leaking and slow or no discoloration occurs. ΔE increases from 14 to 28 days, which indicates that the color difference with respect to the reference is higher after longer aging and the efficiency is preserved.

Additionally, the compositions of both Trial 10 and Trial 11, show a high and very similar ΔE when compared to REF1 references, which indicate that the encapsulating action of the polymer prevents the perfume from leaking and slow or no discoloration occurs.

Again, low ΔE values are obtained when comparing the test compositions to REF2 samples, that is polymer-only in formulations, indicating that the possible color changes are mainly due to the discoloring effect of the perfume.

These results indicate that the polymer/perfume mixture according to the present disclosure maintains its discoloration-mitigating properties over storage times and temperatures.

### Example 9. Additional Discoloration Examples

For this example, two of the polymer/perfume mixtures (MIX8 and MIX10) are separately combined with a base detergent mixture (FORM2). MIX3 includes PERF4, which contains about 50 wt % of perfume raw materials that are typically associated with discoloration, and MIX10 includes PERF5, which contains about 50 wt % of perfume raw materials that are typically associated with discoloration.

The resulting product compositions are stored at the given conditions and assessed for color differences (ΔE, according to the method provided above), compared to reference compositions. For the reference compositions of this example, equivalent amounts of perfume (REF1) or polymer (REF2) are added to the base detergent formulation and then stored under similar time/temperature conditions. Results are provided in Table 9 below.

TABLE 9

| | Base | Polymer/ | Storage | | |
|---|---|---|---|---|---|
| | Detergent | Perfume | Conditions | | |
| | Formulation | Mixture | (Temp./ | ΔE vs. | ΔE vs. |
| Trial | (%) | (%) | Time) | REF1 | REF2 |
| 12 | FORM2 | MIX8 | 40° C./ | 14.0 ± 1.0 | 6.2 ± 1.0 |
| | (96.7%) | (3.3%) | 21 days | | |
| 13 | FORM2 | MIX10 | 40° C./ | 12.8 ± 1.0 | 4.1 ± 1.0 |
| | (96.7%) | (3.3%) | 21 days | | |

As shown in Table 9, the compositions of both Trial 12 and Trial 13, show a high and very similar ΔE when compared to REF1 references, which indicate that the encapsulating action of the polymer prevents the perfume from leaking and slow or no discoloration occurs. The ΔE vs REF1 values, however, are lower with respect to the previous examples. Again, low ΔE values are obtained when comparing Trial 12 and Trial 13 to REF2 references, that is polymer-only in formulations, indicating that the possible color changes are mainly due to the discoloring effect of the perfume. These results indicate that the polymer/perfume mixture according to the present disclosure maintains its discoloring slowing/preventing properties at higher perfume/polymer ratios and with different perfumes.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid consumer product composition comprising fragrance-delivery particles and a consumer product adjunct,
the fragrance-delivery particles comprising a graft copolymer and a fragrance material,
the graft copolymer comprising a polyalkylene glycol as a graft base and one or more side chains that comprise vinyl acetate moieties;
the fragrance material comprising perfume raw materials that comprise an aldehyde moiety, perfume raw materials that comprise a ketone moiety, perfume raw materials that comprise a phenol moiety, or a mixture thereof;
wherein the composition comprises less than 50 wt %, by weight of the composition, of free water.

2. The liquid consumer product composition according to claim 1, where one or more of the perfume raw materials that comprise an aldehyde moiety, perfume raw materials that comprise a ketone moiety, and/or perfume raw materials that comprise a phenol moiety, further comprise one or more carbon double bonds (C═C) and/or an aromatic ring structure.

3. The liquid consumer product composition according to claim 1, wherein the perfume raw materials that comprise an aldehyde moiety, perfume raw materials that comprise a ketone moiety, perfume raw materials that comprise a phenol moiety, or a mixture thereof that are part of the fragrance-delivery particles are:
(a) present in an amount of from about 0.01% to about 5%, by weight of the composition, and/or
(b) present in an amount of from about 1% to about 75%, by weight of the total amount of fragrance material of the particles.

4. The liquid consumer product composition according to claim 1, wherein the fragrance material comprises a perfume raw material selected from: 2,6,10-trimethyl-9-undecenal; amyl cinnamic aldehyde; anisaldehyde; citral; citronellal; cyclal c; cyclamen aldehyde; ethyl vanillin; floralozone; helional; heliotropin; hexyl cinnamic aldehyde; lilial; myrac aldehyde; phenyl acetaldehyde; triplal; undecylenic aldehyde; vanillin; alpha-ionone; beta-ionone; laevo carvone; alpha damascone; delta damascone; iso e super; methyl ionone; eugenol; or mixtures thereof.

5. The liquid consumer product composition according to claim 1, wherein the polyalkylene glycol of the graft copolymer comprises polyethylene glycol (“PEG”).

6. The liquid consumer product composition according to claim 1, wherein the graft copolymer comprises from about 1 to about 10 side chains per graft base.

7. The liquid consumer product composition according to claim 1, wherein the graft copolymer is characterized by a weight ratio of polyalkylene glycol, to vinyl acetate moieties of about 5:1 to about 1:10.

8. The liquid consumer product composition according to claim 1, wherein the graft copolymer is characterized by a weight-average molecular weight of from about 2000 Daltons to about 250,000 Daltons.

9. The liquid consumer product composition according to claim 1, wherein the fragrance-delivery particles are characterized by a number-average diameter of from about 0.5 microns to about 5000 microns.

10. The liquid consumer product composition according to claim 1, wherein the composition comprises less than 20 wt %, by weight of the composition, of free water.

11. The liquid consumer product composition according to claim 1, wherein the consumer product adjunct comprises a member selected from the group consisting of an amine, a surfactant system, a water-binding agent, a sulfite, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, free perfume, structure elasticizing agents, fabric softeners, carriers, fillers, hydrotropes, organic solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

12. The liquid consumer product composition according to claim 1, wherein the consumer product adjunct comprises a surfactant system present in an amount of from about 20% to about 75%, by weight of the composition.

13. The liquid consumer product composition of claim 12, wherein the surfactant system is characterized by at least one of the following:
a) the surfactant system comprises from about 2% to about 15%, or from about 4% to about 12%, by weight of the composition, of nonionic surfactant;
b) the surfactant system comprises from about 0% to about 8%, by weight of the composition, of linear alkyl benzene sulphonate (LAS);
c) the total amount of nonionic surfactant and LAS present in the surfactant system comprises from about 4% to about 15%, by weight of the composition;
d) the weight ratio of nonionic surfactant to LAS is from about 1:3 to about 1:0.

14. The liquid consumer product composition according to claim 1, wherein the consumer product adjunct comprises an amine.

15. The liquid consumer product composition according to claim 1, wherein the consumer product adjunct comprises an alkanolamine.

16. The liquid consumer product composition according to claim 1, wherein the consumer product adjunct comprises a water binding agent selected from the group consisting of organic acids, salts of organic acids, humectants, desiccants, natural sugar substitutes, artificial sugar substitutes, hydrogels, and mixtures thereof.

17. The liquid consumer product composition according to claim 1, wherein the consumer product adjunct comprises a sulfite.

18. The liquid consumer product composition according to claim 1, wherein the composition is a fabric care composition, a hard surface cleaner composition, a dish care composition, a hair care composition, a body cleansing composition, or a mixture thereof.

19. The liquid consumer product composition according to claim 1, wherein the composition is encapsulated in a water-soluble film.

20. A process of treating a surface, the process comprising the step of contacting the surface with the consumer product composition according to claim 1.

21. A process for making a liquid consumer product composition, the process comprising the steps of:
providing a fragrance material,
the fragrance material comprising perfume raw materials that comprise an aldehyde moiety, perfume raw materials that comprise a ketone moiety, perfume raw materials that comprise a phenol moiety, or a mixture thereof;
combining the fragrance material with a graft copolymer to form a feedstock composition,
the graft copolymer comprising a polyalkylene glycol as a graft base and one or more side chains that comprise vinyl acetate moieties;
combining the feedstock composition with a consumer product adjunct to form a liquid consumer product composition,
wherein the consumer product composition comprises perfume-delivery particles formed from the fragrance material and the graft copolymer of the feedstock composition.
